(19) United States
(12) Patent Application Publication
(10) Pub. No.: US 2001/0037404 A1
(43) Pub. Date: Nov. 1, 2001

(54) System for wireless communication of data between a WEB server and a device using a wireless application protocol

(76) Inventors: Gudmundur Hafsteinsson, Reykjavik (IS); Georg Ludviksson, Reykjavik (IS)

Correspondence Address: BIRCH STEWART KOLASCH & BIRCH, PO BOX 747, FALLS CHURCH, VA, 22040-0747, US

(21) Appl. No.: 09/824,675

(22) Filed: Apr. 4, 2001

Related U.S. Application Data
(60) Provisional application No. 60/194,695, filed on Apr. 5, 2000.

(30) Foreign Application Priority Data
Apr. 5, 2000 (IS) 5428
Oct. 11, 2000 (IS) 5658

(51) Int. Cl. G06F 15/16

(52) U.S. Cl. 709/246; 709/203

(57) ABSTRACT

The present invention relates to a system and a method for communication of data between a WEB server and a device using a wireless application protocol, such as a WAP mobile phone. The invention further relates to a method of dynamic, cheaper and faster conversion of data between a first and a second format compliant to the WEB server and the device.

### FIELD OF THE INVENTION

The present invention relates to a system and a method for communication of data between a WEB server and a device using a wireless application protocol, such as a WAP mobile phone. The invention further relates to a method of dynamic, cheaper and faster conversion of data between a first and a second format compliant to the WEB server and the device.

### DESCRIPTION OF THE PRIOR ART

Primarily due to differences in data formats there are currently no means for reading data comprised in e.g. a HTML WEB page from a WAP phone. In order to access WEB page information from a WAP phone, the WEB pages has to be converted. Today the owner of a WEB page typically selects specific data from the WEB page that he wants to make accessible from a WAP phone. The data is then converted and a new data file containing the converted data is created. When a WAP phone customer enters the specific WEB page, it is in reality the data file containing the converted data that is entered.

Due to the duplication of the WEB page information, two data files having different content, even though they disclose the same information, have to be updated. This is both costly and time consuming. Moreover the risk of faults are higher given that two pages must provide identical information in different formats.

It is the purpose of the present invention to enable access to a WEB page directly from such devices as WAP mobile phones by means of inline conversion of data instead of duplication of data. Accordingly the cost of creating a WAP service, if the same service is at hand in a HTML WEB page can be lowered, the risk of faults can be lowered and the costs for maintenance of “WAP” accessible” WEB pages can be reduced.

### GENERAL DESCRIPTION OF THE INVENTION

According to one aspect the invention relates to a system for wireless communication of data between a WEB server and a device using a wireless application protocol. The system comprises a converter for inline conversion of data in a first format as output from the WEB server into a second format to be received by the device or for conversion of data in the second format into data in the first format. The converter may be a processor adapted in a computer system of any kind, such as in a PC. The two data formats could be HTML and WML or any other formats adapted for the two platforms—the WEB server and the WAP device. Inline conversion means that the conversion takes place when a WAP device user requests information comprised in a WEB page, so that the client receives information comprised in the actual WEB page and not information from the WEB page that has earlier been converted.

According to a preferred embodiment of the invention the converter may comprise a computer database wherein output data generated in response to input data is controlled by an identifier of the WEB server data. The identification could be based on a user defined relationship between a number of WEB pages and matching schemas comprising conversion rules for the WEB pages. When a WEB page owner decides to enable conversion of the WEB page into a WAP device compliant format such as WML

The conversion rules may be grouped into the schemas e.g. based on various versions of the two formats e.g. various versions of HTML, XML or WML or they may be grouped based on the type of information being converted.

According to a preferred embodiment of the invention the first format is HTML, XML or a XML compliant format and the second format is WML or a similar a WAP compliant format. If the WEB page is in HTML the HTML could preferably be pre-converted into XML and then the XML format could be converted into WML based on a conversion rule schema.

The system should preferably be adapted to support current standards and most commonly used methods and formats such as the http and the SSL connections.

The system could be implemented in a regular computer system, e.g. implemented in the WEB server and preferably the implementation could be performed by means of platform independent tools such as Java.

According to another aspect the invention relates to a method for conversion of data in a first format as output from a WEB server into a second format to be received by a device using a wireless application protocol said method comprising the steps of inline:

reading from the device a request for data from a WEB server address,

converting the request from a first data format to a second data format,

forwarding the converted request to the WEB server,

receiving data from the WEB server address,

converting the data from the second data format to the first data format,

forwarding the data to the device.

Preferably the conversion may be based on a set of conversion rules related to the requested data and preferably such rules are grouped in templates based on characteristics of the requested data e.g. the data format of the requested data etc. The owner of a WEB page can then chose between a number of conversion templates for conversion of a specific WEB page.

### BRIEF DESCRIPTION OF THE DRAWINGS

A system based on a preferred embodiment of the invention will now be described in detail with reference to the drawings in which:

FIG. 1 shows a general overview of a system according to the present invention,

FIG. 2 shows an overview of the transformation process.

### DETAILED DESCRIPTION OF THE INVENTION

The invention will in the following be described by means of an example of a system for conversion of data formats for exchange of data between a WEB server and a WAP device. The system makes it quicker and cheaper than currently possible to publish HTML content in a WAP device. By use of the system, any existing HTML content can be transformed to the WAP device's native format WML. Therefore virtually any service currently available on the Internet can be made available to WAP devices in a matter of a few hours or days.

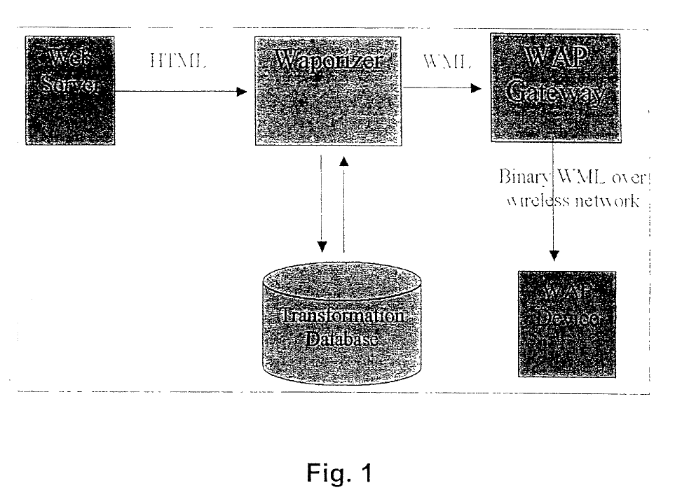

The system acts as a filtering proxy, meaning that it processes and alters all requests from the WAP device and all responses from the HTML web server. No alterations are needed on the server as long as it is at least HTTP 1.0 compliant and as long as the WAP device is compliant it should be able to display the response given from the system (since it is fully compliant with the WAP standard as defined by the WAP forum). A general overview is shown in FIG. 1 in which the system is shown in blue.

The functionality's of the system can be grouped into two parts. First of all it transforms HTML content into WML content which can be displayed on WAP devices. Secondly it handles requests from WAP devices and responses from web servers, serving HTML content. A part of that process is to offer functionality not available in current WAP devices, such as cookies, and also to save bandwidth, e.g. by caching big HTML parameters. Each part will now be described separately.

The system is preferably a Java application that is run as a servlet within a servlet engine. Currently the system has been tested on Apache with JServ as servlet engine, both on Linux and Windows NT server and workstation platforms, and on IIS with Jrun as servlet engine running on Windows NT. It is developed on a Windows NT server running Apache 1.3.11 with JServ 1.1, and is periodically deployed on a Linux computer running RedHat 6.1 and Apache 1.3.12 with JServ 1.1. The system should be able to run on any JSDK 2.0 compliant servlet engine on any platform without modifications.

The purpose of the filtering process is to take an HTML web page and transform it into a WML page which WAP devices can read. The process is not automatic in the sense that all pages can be converted by the means of a single transformation, but rather that certain HTML pages or URLs that refer to HTML pages are paired with a certain transformation document. When the HTML content changes (not the layout) the WML page changes simultaneously as it is always transformed from the same dynamic HTML page. A given HTML page can be transformed into many WML pages by using many different transformations.

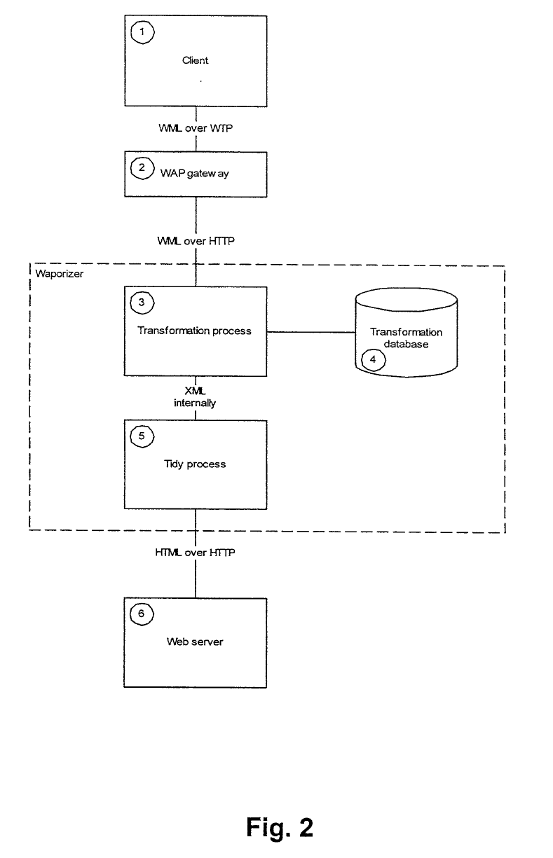

FIG. 2 shows how HTML files are transferred into XML and then into WML.

According to a preferred embodiment of the system all transformations are written using the generic transformation language XSLT which is a W3C recommendation and is part of the XSL standard's working draft. The problem is that XSL only works for well formed XML documents, and so the HTML content must be converted into XML before being processed with XSL. In order to make this change, the HTML document is put through a so called tidy process, which transforms a generic HTML document into a well formed (and legal) XML document. This may be done with a publicly available application called Tidy which takes an HTML input stream and gives out an XML output stream.

This part is marked numbered (5) in FIG. 2.

Given the XML version of the HTML document, it is put through an XSL transformation process. This is a highly standardised and very well documented process.

The communication part hands a reference to the transformation document to the transformation part. Preferably it is passed in as a parameter in the HTTP GET request from the WAP device, but other possibilities could be used without altering the filtering process itself.

All transformations are currently stored as files on the server that the system is running on. All files are encrypted e.g. with a 1024 bit private RSA key to ensure they can neither be inspected nor tampered with.

All license information is stored in specific license files, one for each domain, each specifying which domain(s) is/are a part of that license, how many concurrent sessions can be active and the timeout for each session. The license files are encrypted with the same private key as the transformation files.

The system is a servlet that is run on any network connected servlet enabled web server. The physical and logical location of that server is not relevant, as long as connections can be made to the requesting client and the serving server. The following details the process that the system follows.

1. A client requests a connection with the system servlet. How this is mapped to an URL depends on the servlet engine the system is running on. The system then connects to the serving server and retrieves the requested HTML document. How this is done is described in detail below.

2. Given an HTML document and an XSL document the document is transformed into a WML document. How this is done is described in detail in the Transformation Process section below.

3. The WML document is sent back to the client along with appropriate server response headers which the serving server sent back to the system. How this is done in detail is described in detail in the Response Process section below.

The connection process is as follows:

1. The client sends in parameters to the system requesting a certain URL which contains an HTML document and what transformation to use to transform the HTML document.

2. The requested URL is transmitted with a parameter e.g. called uri, which is a normal URL except for all ampersands (&) are converted to exclamations (!). This conversion is done so that system does not attempt to respond to parameters that are given in the URL.

3. The requested transformation is given with a parameter e.g. called xxx. This is a unique name which is mapped to a certain transformation document which is of type XSL. How this name is interpreted depends on the Transformation Process.

4. If a session does not exist for the connection a new one is made. Session control is done through the serviet engine which supports sessions with URL rewriting, which is necessary as WAP devices do not currently support cookies.

5. The system does next a license check. Licenses are described in enciphered license files and are read in beforehand and kept in memory. Licenses describe what domains may be accessed through that license, how many concurrent connections can connect through that license and the length of the timeout for sessions through that license.

6. The system makes a connection to the URL given by the client and forwards certain request parameters. What parameters are forwarded depends on the HTTP 1.1 standard as described in RFC-2616. The system acts as a proxy in this case.

7. The following headers are currently forwarded:

Accept-Charset

User-Agent

Authorization

In addition the following headers are sent:

Via—the system and version number is added to the received Via header.

Accept—Is set to “text/html, text/vnd.wap.wml”.

Connection—Is set to “Close” in conformance with RFC-2616.

Cookie—Is set according to what cookies have been set by the server for that session within that domain. Cookies are described in RFC-2109.

8. The system performs the same type of request to the server as the client did to the system, e.g. GET or POST.

9. The system sends all request parameters sent by the client, except when the client requests a server side parameter caching. In that case all parameters are cached until the next request from that session that does not request caching is done, in which case they are sent with other parameters of the request. This is used as a workaround for some WAP devices limiting the length of the GET and POST request strings (sometimes to as little as 127 bytes).

10. All response headers and the response code are kept for the Response Process and then the connection is closed in conformance e.g. with RFC-2616 (the HTTP 1.1 standard).

11. The system preferably supports both normal http and SSL (hftps) connections. The normal http connection is implemented by the standard Java package java.net and the SSL connection is implemented by the reference implementation of JSSE by Sun which is a royalty free implementation which may be used in commercial applications.

The transformation process may be as follows;

1. The system checks if a transformation document with the given name exists. Currently all transformation documents are XSL, which is a working draft due to become an open standard and is described by World Wide Web Consortium. All transformations are stored enciphered on the local disk and read in beforehand for added performance. The enciphering code is a clean house implementation of the JCE (Java Cryptography Extension) interface as defined by Sun, implemented by eSec Ltd. which is licensed under ABA Public License.

2. The HTML document is run through a cleaning process called Tidy. This process is necessary to turn the HTML document into an XML compliant document, because XSL can only transform XML compliant documents. The tidy process may either be implemented as part of the system or it may be executed as an external process. The Tidy component may be obtained as a royalty free component which may be used in commercial applications.

3. The tidied HTML document (hereafter called the XML document) is transformed with the given transformation document. Before this transformation process is run a few XSL variables are added to the transformation document on the fly in order to aid the transformation process. The variables are:

waporURL—The URL of the system. This is done in order to make the system more portable and to maintain any sessions that may be going on.

param—A general passing parameter passed in by the client and may be used by the transformation process in any way. Currently there is only one parameter but it is planned to make a general mechanism in order to allow any number of parameters.

These parameters are only visible in the current transformation and are not the same as WML variables.

4. The transformation process is currently implemented by XT. XT also uses an XML parser from IBM, XML4J.

5. The output of this transformation process (a WML document) is sent to the Response Process.

The response process may be as follows:

1. The system already has an open connection to the client and forwards certain HTTP headers from the serving server as described in RFC-2616 (the HTTP 1.1standard).

The headers that are forwarded are:

www-authenticate

server

cache-control

2. The system sends the response code from the server.

3. The system sends the WML document which was the result of the transformation process to the client.

Preferred technical features of the system are:

Platform independence, which can reside anywhere between the mobile user and the HTML content.

Use of open standards.

Support of secure connections (SSL and TLS), both incoming and outgoing.

Support of cookies and session control.

Graphical interface for creating transformations quickly and easily.

1. A system for wireless communication of data between a WEB server and a device using a wireless application protocol, comprising a converter for inline conversion of data in a first format as output from the WEB server into a second format to be received by the device or for conversion of data in the second format into data in the first format.

2. A system according to claim 1, wherein the converter comprises a computer database wherein output data generated in response to input data is controlled by an identifier of the WEB server data.

3. A system according to claim 1 or 2, wherein the identifier of the WEB server data selects a pre-specified conversion rule scheme based on a pre-classification of the WEB server data.

4. A system according to any of the preceding claims, wherein the first format is an XML compliant format and wherein the second format is a WAP compliant format.

5. A system according to any of the preceding claims, wherein the first format is HTML and wherein the second format is WML.

6. A system according to claim 5, wherein the first format is converted into an intermediate format and wherein the intermediate format is XML.

7. A system according to any of the preceding claims, wherein the system is adapted to support the http and the SSL connections.

8. A system according to any of the preceding claims, wherein the system is implemented in a computer system by means of Java.

9. A method for conversion of data in a first format as output from a WEB server into a second format to be received by a device using a wireless application protocol said method comprising the steps of inline:
reading from the device a request for data from a WEB server address,
converting the request from a first data format to a second data format,
forwarding the converted request to the WEB server,
receiving data from the WEB server address,
converting the data from the second data format to the first data format,
forwarding the data to the device.

10. A method for conversion of data according to claim 9, wherein the conversion is based on a set of conversion rules related to the requested data.

11. A method for conversion of data according to claim 9 or 10, wherein the set of conversion rules are grouped into conversion templates according to characteristics of the requested data.

12. A method for conversion of data according to claim 11, wherein a group of conversion rules are selected in relation to requested data.
